(19) United States
(12) Patent Application Publication
(10) Pub. No.: US 2004/0233176 A1
(43) Pub. Date: Nov. 25, 2004

(54) TOUCH PANEL WITH MAGNETIC DISPLAY UNIT

(76) Inventors: Bar-Long Denq, Taipei City (TW); Jen-Chun Wang, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/709,503

(22) Filed: May 11, 2004

(30) Foreign Application Priority Data
May 23, 2003 (TW) 092114005

(51) Int. Cl. G09G 5/00

(52) U.S. Cl. 345/173

(57) ABSTRACT

A touch panel includes a plurality of display units arrayed in a matrix. Each of the display units includes a container containing magnetic materials, a transparent film installed on the surface of the container, a first isolating component installed on a base and a portion of the sidewalls of the container for isolating neighboring container and carrying the magnetic materials, a second isolating component for separating the container into two chambers and carrying the magnetic materials, wherein there is an opening between the two chambers to make the magnetic materials flow between the two chambers, and at least an electromagnetic apparatus installed under the plurality of display units to act as a base and used for generating a magnetic field to make the magnetic materials separate from the surface of the second isolating component.

### BACKGROUND OF INVENTION

1. Field of the Invention

The present invention relates to a touch panel, and more specifically, to a touch panel with a magnetic display unit.

2. Description of the Prior Art

In modern information-oriented society, a large quantity of data is communicated, processed, and stored in digital data format, thus computers used for reading and accessing data have become very important tools. Especially portable computers such as notebooks and personal digital assistants (PDAs), which by their small size, lightness, and portability, help users to search, browse, and store various kinds of data at anytime at any place. Therefore, portable computers have become one of the most important digital data platforms and the focus of much development.

Concerning portable computers, both compactness and usability of the human input interface are emphasized; therefore a touch panel is used as part of the man machine interface (MMI). When a user touches or presses on the touch panel, the touch panel can sense the position or even the strength of the stress and control the computer according to the associated command. Furthermore, as handwriting recognition technology progresses, users can write data directly on the touch panel, and the portable computer can recognize and store the data input according to the handwriting sensed by the touch panel. Handwriting input can not only reduce the size of the portable computer so that a keyboard is not necessary, but also provide an improved interface for users to control the computer in a direct way using the touch panel.

However, when handwriting input is proceeded, a conventional touch panel cannot display the trace being written directly on the touch panel, so that it is inevitable to look up to a monitor while writing characters in order to ensure proper handwriting, which not only influences the convenience and speed of handwriting but also lowers the recognition accuracy in the cases of characters having many strokes due to uncertainness of the relative positions of each stroke. Therefore, improvements in handwriting on a touch panel are required.

### SUMMARY OF INVENTION

It is therefore a primary objective of the present invention to provide a touch panel to solve the problems mentioned above.

Briefly summarized, a touch panel includes a plurality of display units arrayed in a matrix. Each of the display units includes a container containing magnetic materials, a transparent film installed on the surface of the container, a first isolating component installed on a base and a portion of the sidewalls of the container for isolating neighboring containers and carrying the magnetic materials, a second isolating component for separating the container into two chambers and carrying the magnetic materials, wherein there is an opening between the two chambers to make the magnetic materials flow between the two chambers, and at least one electromagnetic apparatus installed under the plurality of display units to act as a base and used for generating a magnetic field to make the magnetic materials separate from the surface of the second isolating component.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates a touch panel installed on a notebook.

FIG. 2 illustrates a user inputting data into the notebook by writing on the touch panel.

FIG. 3 is a block diagram of the notebook and the touch panel.

FIG. 4 illustrates the touch panel according to the present invention.

FIG. 5 is a cross sectional diagram of the touch panel along line 5-5′ in FIG. 4.

FIG. 6 is an enlarged diagram of one of the display units in FIG. 5.

FIG. 7 is an enlarged diagram of one of the display units in FIG. 5 according to the second embodiment.

FIG. 8 is an enlarged diagram of one of the display units in FIG. 5 according to the third embodiment.

FIG. 9 is an enlarged diagram of one of the display units in FIG. 5 according to the fourth embodiment.

FIG. 10 is a cross sectional diagram of the touch panel along line 5-5′ in FIG. 4.

### DETAILED DESCRIPTION

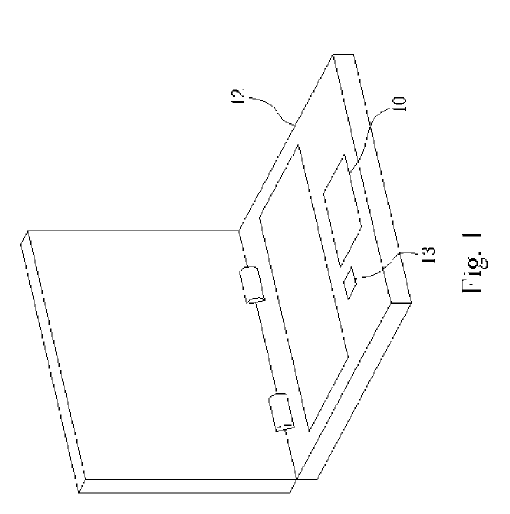

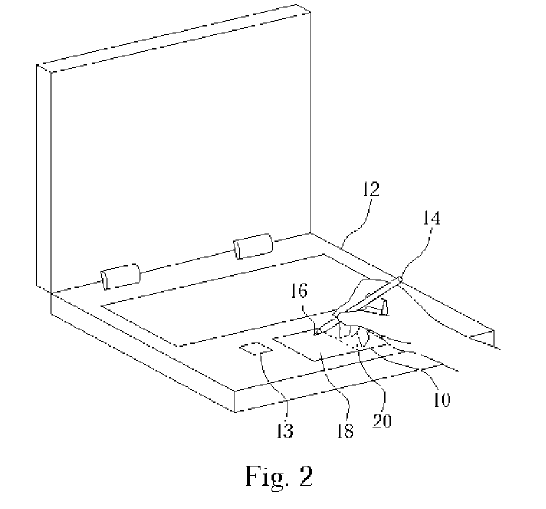

Please refer to FIG. 1 showing a touch panel 10 installed on a notebook 12. The touch panel 10 can also be installed on a PDA or a tablet computer. A user can input data into the notebook 12 by writing on the touch panel 10 or by using the touch panel 10 in replacement of a mouse to move a cursor. The touch panel 10 includes an electromagnetic apparatus switch 13. FIG. 2 shows the user inputting data into the notebook 12 by writing on the touch panel. The touch panel 10 is divided into a first input area 18 and a second input area 20 for data input. When the user writes data on the touch panel 10 with a stylus 14, the touch panel 10 can sense a stress point 16 of the stylus 14 and recognize the data or commands input into the notebook 12 according to the handwriting trace formed by the displacement of the stress point 16.

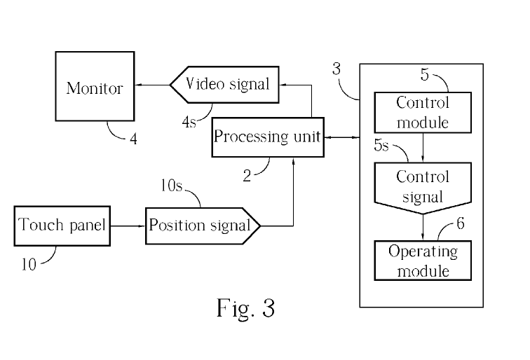

Please refer to FIG. 3. FIG. 3 is a block diagram of the notebook 12 and the touch panel 10. The touch panel 10 can sense the position where the stylus 14 presses and makes contact with the touch panel 10 and generate a corresponding position signal 10s. The notebook 12 includes a processing unit 2, a memory 3 and a monitor 4 for displaying images. The processing unit 2 processes the operation of the notebook 12, which includes a central processing unit (CPU) for processing data, an interface circuit for integrating the position signal 10s, an image circuit for controlling the monitor 4 with a video signal 4s, and a flash memory for nonvolatile data storage (not shown in the figure). The processing unit 2 processes data and the corresponding operations according to programs installed in the memory 3. The memory 3 can be a random access memory (RAM).

A control module 5 and an operating module 6 installed in the memory 3 control the touch input of the present invention. The operating module 6 can be an operating system (OS) of the notebook 12 or handwriting recognition software. The control module 5 processes touch input and converts data into control signals 5s acceptable by the operating module 6. The position signal 10s generated by the touch panel 10 is transmitted to the controls module 5 via the processing unit 2 in the proper format, and the control module 5 generates the corresponding control signals 5s to the operating module 6 according to the position signals 10s. The operating module 6 then executes corresponding operations through the processing unit 2 to control the notebook 12 after receiving the control signals 5s. For example, when the user writes a character on the touch panel 10, the touch panel 10 transmits the position signal 10s corresponding to the character to the processing unit 2, and the processing unit 2 converts the position signal 10s into proper data format and transmits it to the control module 5. The control module 5 then generates the corresponding control signal 5s to the operating module 6. In this example, the operating module 6 is handwriting recognition software. The control signal 5s is recognized as a corresponding character signal by the handwriting recognition software and output to the processing unit 2. The processing unit 2 then outputs the video signal 4s to control the monitor 4 to display the character. The recognition and the handwriting input operations are conducted simultaneously.

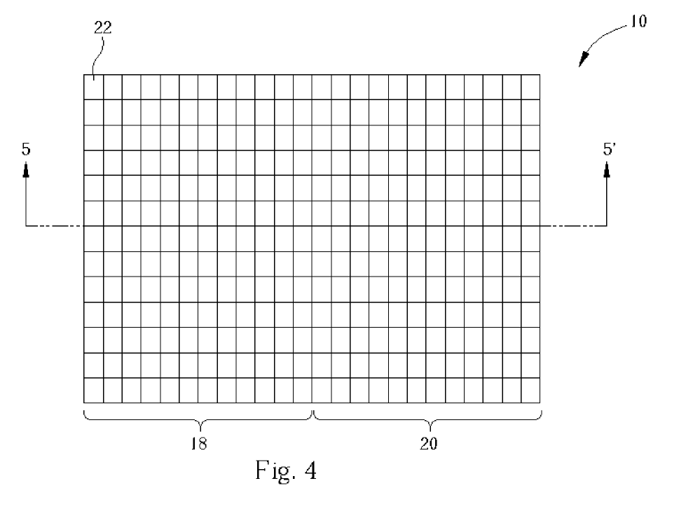

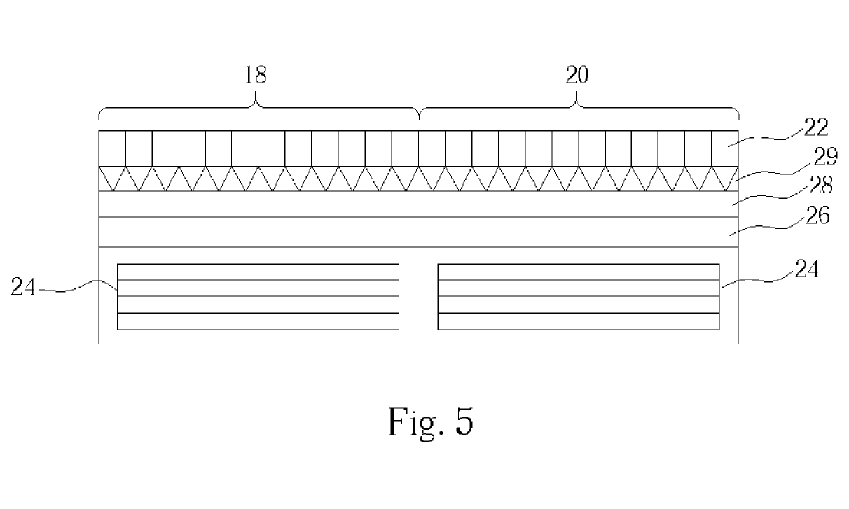

Please refer to FIG. 4 showing the touch panel 10 according to the present invention. The touch panel 10 is divided into a first input area 18 and a second input area 20 for data input. The first input area 18 and the second input area 20 can be further divided into a plurality of display units 22. The plurality of display units 22 is arrayed in matrix form, and the quantity can be determined by the required resolution. If a high resolution is required, the touch panel 10 can be divided into a larger amount of smaller display units, and vice versa. Please refer to FIG. 5 showing a cross sectional view of the touch panel 10 along line 5-5′ in FIG. 4. The display units 22 are on the top of the touch panel 10, and two electromagnetic apparatuses 24 are installed respectively under the first input area 18 and the second input area 20 to act as bases of the display units 22. The two electromagnetic apparatuses 24 are magnetic when electrified and can be formed by electromagnetic field coils. A panel layer 28 is installed between the electromagnetic apparatuses 24 and the display units 22, formed from a resistive panel layer or a capacitive panel layer, used for outputting the corresponding position signal 10s to the processing unit 2 when the touch panel 10 is used. A sensor layer 26 is installed under the panel layer 28, which can be composed of piezoelectric materials. And a contact layer 29 is installed between the display units 22 and the panel layer 28, which possesses a plurality of protruding materials for pressing the panel layer 28 and the sensor layer 26 according to the handwriting written on the display units 22.

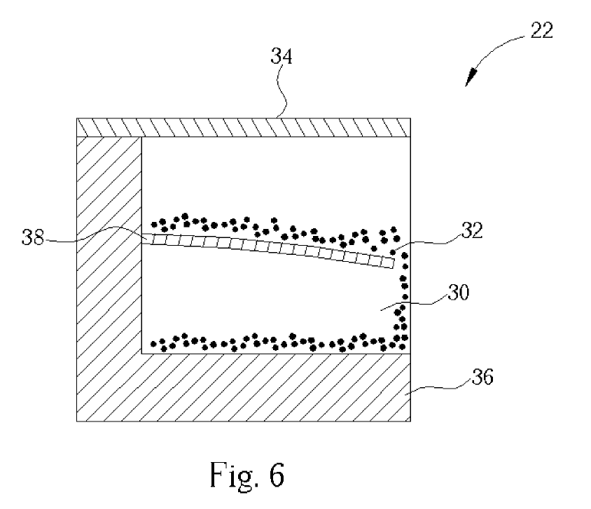

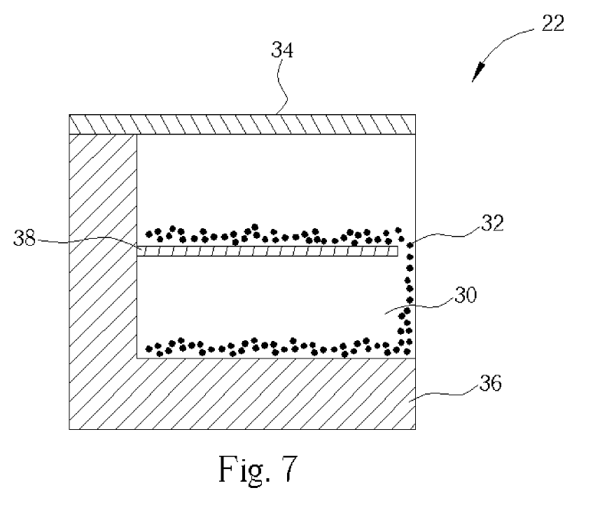

Please refer to FIG. 6 showing an enlarged view of one of the display units 22 in FIG. 5. The display unit 22 includes a container 30 containing magnetic materials 32, which can be magnetic powder or other magnetic fluid materials. A transparent film 34 is installed on the surface of the container 30 and is composed of insulating materials used for displaying the input trace when the touch panel 10 is pressed, wherein the above-mentioned surface is located at the top of the container 30. A first isolating component 36 installed on a base and a portion of the sidewalls of the container 30 is composed of insulating materials such as plastic or rubber and is for isolating the magnetic materials 32 in the two neighboring containers 30. A second isolating component 38, which is composed of insulating materials such as plastic or rubber, is for separating the container 30 roughly into two chambers and carrying the magnetic materials, wherein there is an opening between the two chambers to make the magnetic materials flow between the two chambers. The second isolating component 38 has an angle of inclination so that the magnetic materials 32 will slide to the lower chamber through the opening by magnetic force when the electromagnetic apparatuses 24 are turned on but stay in the upper chamber when the electromagnetic apparatuses 24 are turned off. Please refer to FIG. 7 showing an enlarged view of one of the display units 22 in FIG. 5 according to the second embodiment of the present invention. The display unit 22 according to the second embodiment differs from that of the first embodiment in that the second isolating component 38 is installed horizontally for separating the container 30 into two chambers, wherein there is an opening between the two chambers to make the magnetic materials flow between the two chambers. If the electromagnetic apparatuses 24 can generate enough magnetic force to drag the magnetic materials 32 to the lower chamber, the second embodiment can be adopted.

In the case that the panel layer 28 is resistive and the stylus 14 is magnetic, before writing, the two electromagnetic apparatuses 24 are turned on to generate a magnetic field to drag the magnetic materials 32 to the lower chamber so that a trace made by the magnetic materials 32 cannot be seen through the transparent film 34. When the user writes a character by the stylus 14 on the first input area 18, the sensor layer 26 senses a stress at the stress point 16 of the stylus 14 and converts the stress into an electric signal. The electric signal is transmitted to the electromagnetic apparatus switch 13 in order to turn off the electromagnetic switch 24 under the first input area 18 pressed by the stylus 14. Meanwhile, the magnetic materials 32 are attracted by the magnetic stylus 14 from the lower chamber to the upper chamber by passing through the opening and show the trace on the second isolating component 38, allowing the user to see the trace shown by the magnetic materials 32 through the transparent film 34.

When the user lifts the stylus 14 from the touch panel 10 for a period of time (which can be determined according to the requirements, e.g. 200 ms) due to completing or abandoning the input of a character, the sensor layer 26 senses no stress on the touch panel 10 and outputs an electrical signal to the electromagnetic apparatus switch 13 in order to turn on the electromagnetic switch 24 under the first input area 18. The magnetic materials 32 are again attracted to the lower chamber and the trace cannot be seen through the transparent film 34, in other words, the trace is erased. Meanwhile, the panel layer 28 outputs the corresponding position signal 10s according to the trace, the processing unit 2, and the handwriting recognition software for character recognition. The user can write a next character in the first input area 18 or the second input area 20. The purpose of the second input area 20 is for users to write the next character without waiting for the electromagnetic apparatus 24 to be turned on for attracting the magnetic materials 32 to the lower chamber through the opening to erase the trace. The input of the next character is essentially the same to the above-mentioned description, thus a further description is hereby omitted.

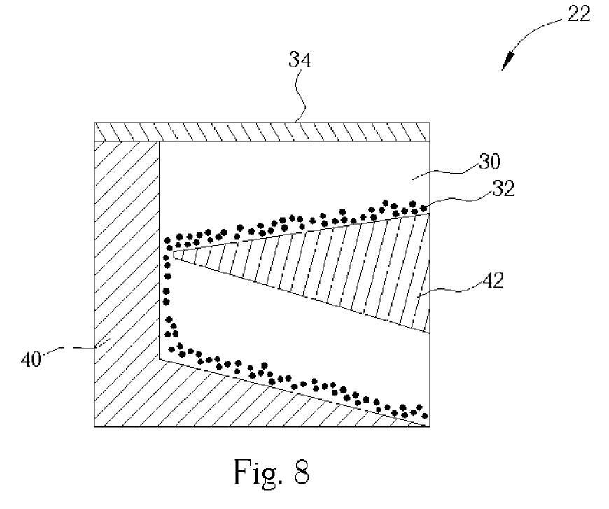

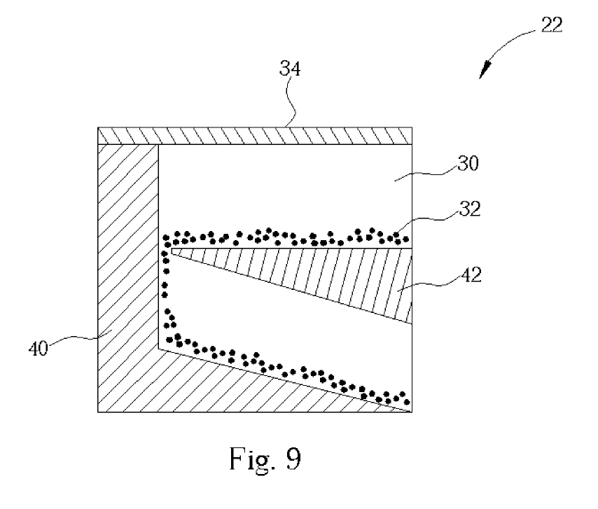

The inner structure of the display unit 22 varies in different types. Please refer to FIG. 8 showing an enlarged view of one of the display units 22 in FIG. 5 according to the third embodiment of the present invention. The display unit 22 also includes a container 30 containing magnetic materials 32 which can be magnetic powder or other magnetic fluid materials. A transparent film 34 is installed on the surface of the container 30 and is composed of insulating materials used for displaying the input trace when the touch panel 10 is pressed. A third isolating component 40 is installed on the side of and underneath the container 30 and is composed of insulating materials such as plastic or rubber for isolating the magnetic materials 32 in two neighboring chambers of the container 30. A fourth isolating component 42, which is composed of insulating materials such as plastic or rubber, is for separating the container 30 into roughly two chambers. The fourth isolating component 42 in FIG. 8 also has an angle of inclination, so that the magnetic materials 32 will slide to the lower chamber by magnetic force when the electromagnetic apparatuses 24 are turned on and stay in the upper chamber when the electromagnetic apparatuses 24 are turned off. Please refer to FIG. 9 showing an enlarged view of one of the display units 22 in FIG. 5 according to the fourth embodiment of the present invention. The display unit 22 according to the fourth embodiment differs from that of the third embodiment in that the fourth isolating component 42 is horizontally installed for separating the two chambers in the container 30. If the electromagnetic apparatuses 24 can generate enough magnetic force to drag the magnetic materials to the lower chamber, the fourth embodiment can be adopted. The third and the fourth embodiments differ from the first and second embodiments in the structure of the isolating components, the rest of the features are essentially the same and, therefore, a further description is hereby omitted.

In the case that the panel layer 18 is capacitive and the stylus 14 is magnetic and capacitive with the touch panel sensing using the conventional charge-transfer method, the trace display of the touch panel 10 is essentially the same to the above-mentioned description. The only difference is that the sensor layer 26 senses the stress by detecting the transference of the sensing charge influenced by the capacitive stylus 14. The rest of the features are essentially the same, thus a further description is hereby omitted.

In the above-mentioned embodiments, the panel layer 28 is installed between the electromagnetic apparatuses 24 and the display units 22. However, the panel layer 28 can also be installed above the display units 22 in the case that the panel layer 28 does not influence the trace display by the display units 22, e.g. the panel layer is a transparent indium tin oxide (ITO) glass.

In the above-mentioned embodiments, the electromagnetic apparatus switch 13 switches the electromagnetic apparatuses 24 according to signals from the sensor layer 26. However, the electromagnetic apparatus switch 13 can be a manual switch. This means that when writing on the touch panel 10, the user manually turns off the electromagnetic apparatuses 24 with the electromagnetic apparatus switch 13 so that the magnetic materials 32 are attracted to the upper chamber by the stylus 14 through the opening. When finished, the user manually turns on the electromagnetic apparatuses 24 so that the magnetic materials 32 are attracted to the lower chamber through the opening to erase the trace.

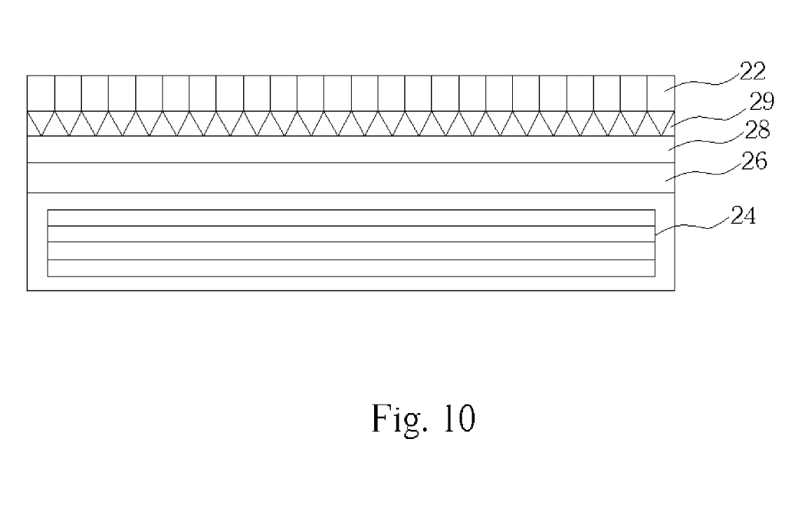

Please refer to FIG. 10 showing a cross section view of the touch panel 10 along line 5-5′ in FIG. 4. The touch panel 10 can also include only one electromagnetic apparatus 24 installed under the sensor layer 24, which means that only one input area is provided for handwriting input and characters and symbols are input one by one in the input area. The numbering and functions of the devices in FIG. 10 are essentially the same to that in FIG. 5, thus a further description is hereby omitted.

In case of the touch panel 10 does not include the panel layer 28, the apparatus simply displays the handwriting trace. This implementation can be used as a write-board or an educational tool for children in replacement of blackboards or whiteboards.

In contrast to the prior art, the touch panel according to the present invention is capable of displaying the trace while writing so that it is not necessary to look up to a monitor while writing characters. This increases the convenience and input speed and raises the recognition accuracy when characters have many strokes. Therefore the present invention fully resolves the problems in the prior art.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A touch panel comprising:
a plurality of display units arrayed in a matrix, each of the display units comprising:
a container containing magnetic materials;
a transparent film installed on a surface of the container;
a first isolating component installed on a base and a portion of the sidewalls of the container for isolating neighboring containers and carrying the magnetic materials;
a second isolating component for separating the container into two chambers and carrying the magnetic materials, wherein there is an opening between the two chambers; and
at least an electromagnetic apparatus installed under the plurality of display units to act as a base and used for generating a magnetic field to make the magnetic materials separate from a surface of the second isolating component.

2. The touch panel of claim 1 wherein the first isolating component is composed of insulating materials.

3. The touch panel of claim 1 wherein the second isolating component is composed of insulating materials.

4. The touch panel of claim 1 further comprising a panel layer for outputting a corresponding touch signal to a processor when pressed.

5. The touch panel of claim 4 wherein the panel layer is installed between the electromagnetic apparatus and the plurality of display units.

6. The touch panel of claim 4 wherein the panel layer is installed above the plurality of display units.

7. The touch panel of claim 4 wherein the panel layer is a capacitive panel layer.

8. The touch panel of claim 4 wherein the panel layer is a resistive panel layer.

9. The touch panel of claim 4 further comprising a sensor layer for detecting whether the panel layer is pressed.

10. The touch panel of claim 1 wherein the electromagnetic apparatus is an electromagnetic field coil.

11. The touch panel of claim 1 further comprising two electromagnetic apparatuses installed under the plurality of display units.

12. The touch panel of claim 1 wherein the magnetic materials in the container are magnetic powder.

13. The touch panel of claim 1 wherein the transparent film of each of the display units is composed of insulating materials.

14. The touch panel of claim 1 further comprising an electromagnetic apparatus switch to switch the electromagnetic apparatus on and off.

15. The touch panel of claim 4 further comprising a contact layer installed between the plurality of display units and the panel layer, for transferring the stress from the plurality of display units to the panel layer and the sensor layer.

16. The touch panel of claim 1 wherein the contact layer comprises a plurality of protruding materials.
